(19) United States
(12) Patent Application Publication
(10) Pub. No.: US 2010/0051072 A1
(43) Pub. Date: Mar. 4, 2010

(54) BUILT-IN DISHWASHING MACHINE

(75) Inventor: Enrico Brambilla, Milano (IT)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS CORPORATION N.V., Zaventem (BE)

(21) Appl. No.: 11/910,939

(22) PCT Filed: Mar. 24, 2006
(86) PCT No.: PCT/EP06/61039

§ 371 Date: Sep. 2, 2008

(30) Foreign Application Priority Data
Apr. 22, 2005 (EP) 05103306.6

(51) Int. Cl. B08B 3/00

(52) U.S. Cl. 134/56 D

(57) ABSTRACT

The present invention relates to a built-in dishwashing machine wherein a capacitive control input system (13) is provided. The built-in dishwashing machine according to the invention comprises a washing chamber, a first door (2) to be opened for accessing the washing chamber and a second door (7) covering the first door (2). The dishwashing machine is characterised in that the second door (7) comprises a capacitive control input system (13) placed between the first (2) and the second door (7).

The present invention relates to a built-in dishwashing machine wherein a capacitive control input system is provided.

Built-in dishwashers of known type generally comprise a cabinet of standardised size, in order to be inserted in a piece of furniture, and a first door to be opened for accessing the washing chamber. The first door is typically hinged on the lower edge of the washing chamber frontal aperture by means of an articulated lever system.

When the machine is installed in a piece of furniture, a second door having decorative functions, is applied on the first door of the machine for covering it, thereby hiding completely the dishwasher in the piece of furniture. The first and second door are coupled one another such that an opening/closing movement is transferred from the second to the first door. In this way, when the second door is closed, the impression of a viewer is that of being looking at a common kitchen furniture rather than a dishwashing machine.

In most cases the second door covers completely the first door of the machine and, in particular, it covers the whole frontal part of the machine. Therefore the problem of making the machine commands reachable by the user arises. Since the frontal part of the machine is completely covered, the machine commands are generally placed in the upper edge of the first door, so that, when the user opens said door, he can immediately see and access the commands.

Such embodiment has the disadvantage that every time the user has to input a command to the machine, for example when he wants to modify the machine program, he must open the dishwashing machine to access the command keyboard interrupting the washing cycle if the machine is working, or with the risk of diffusing malodours in the room where the dishwasher is placed if dirty dishes are contained in the washing chamber.

It is therefore an object of the present invention to provide a built-in dishwasher that can receive input commands by a user without the need of opening and/or accessing the washing chamber door.

A further object of the present invention is to provide a built-in dishwasher that do not need external buttons to be pushed for inputting commands to the machine thereby avoiding to create through aperture on the decorative panel covering the machine door.

Advantages, objects, and features of the invention will be set forth in part in the description which follows and in part will become apparent to those having ordinary skill in the art upon examination of the following or may be learned from practice of the invention. The objects and advantages of the invention may be realised and attained as particularly pointed out in the appended claims.

The accompanying drawings, which are included to provide a further understanding of the invention and are incorporated in and constitute a part of this specification, illustrate an embodiment of the invention and together with the description serve to explain the principles of the invention.

In the drawings:

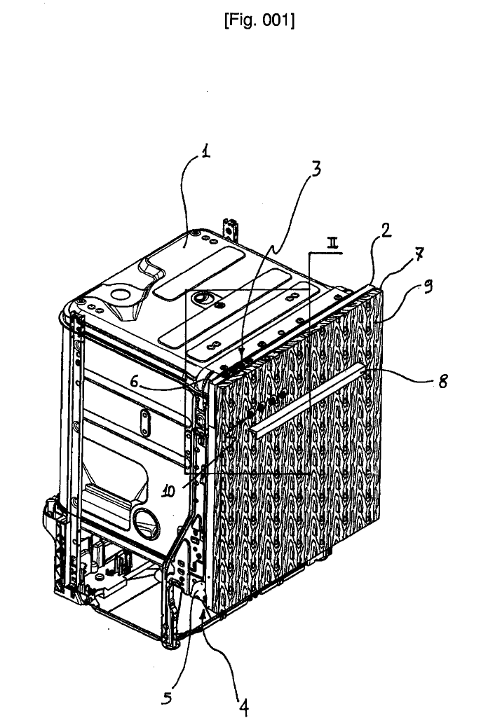

FIG. 1 shows in a perspective view a built-in dishwashing machine according to the present invention;

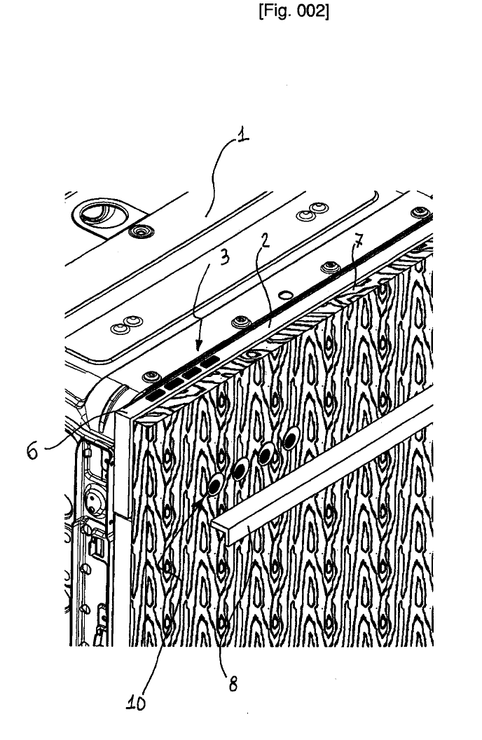

FIG. 2 shows the detail II of FIG. 1;

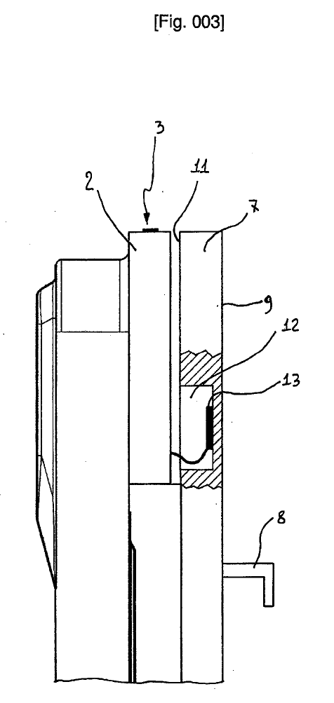

FIG. 3 shows in a sectional view the first and the second door with a capacitive control input system arranged between them.

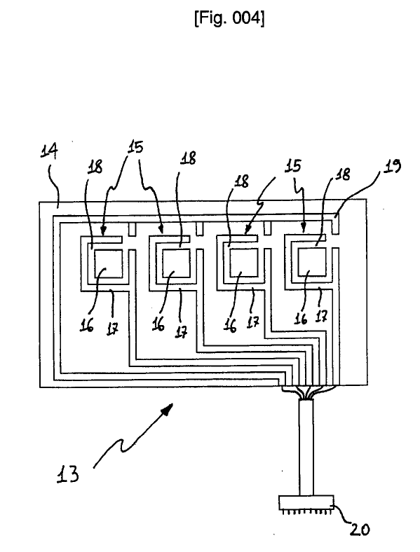

FIG. 4 shows a capacitive control input system as viewed from the back surface of the second door.

With reference to FIG. 1 the built-it dishwashing machine according to the invention comprises a cabinet 1 having a standardised shape in order to be mounted in a piece of furniture. In the interior region of the cabinet 1 a dishwashing chamber of a known type (not shown in FIG. 1) is provided. The machine comprises a first door 2 allowing the washing chamber to be accessed by a user. The first door 2 is pivotally hinged in its lower portion 4 by means of an articulated lever mechanism 5 of known type.

A second door 7, covering the first door 2, is provided for hiding the dishwashing machine in the piece of furniture in which it is mounted. The second door 7 is removably coupled to the first door 2 such that when a user acts on a handle 8 provided on the outer front surface 9 for imparting a movement to the second door 7, said movement is transferred to the first door 2. The second door 7 can be of any desired material such as wood, plastic material, composite material and any other typical material used in the field of furniture production.

As shown in FIG. 1, the dishwashing machine can optionally be provided with a keyboard 3, of known type, mounted in a traditional way on the upper edge 6 or the first door 2 such that, when the latter is in a opened position the user has the possibility to input commands to the machine in a simple way. When the first door 2 is in a closed position the keyboard 3 is hidden by the piece of furniture in which the dishwashing machine is built in and it cannot be used for inputting commands to said machine.

Referring now also to FIG. 2, the outer front surface 9 of the second door 7 is provided with symbols 10 each corresponding to one or more input commands. Such symbols 10 can be formed on the surface 9 in various manner as, for example, by placing one or more stickers showing icons, by depicting the surface 9, or by means of a pyrography. Obviously other known methods can be equivalently used to form said symbols 10 on the surface 9.

In order to allow the user to input commands to the dishwashing machine even when the first and second doors 2 and 7 are closed, that is when the keyboard 3, if present, is hidden by the piece of furniture in which the dishwasher is placed, a capacitive control input system 13 is arranged between said doors. Such capacitive system 13 does not require that the front surface 9 of the second door 7 is drilled to bring buttons and/or switches on said surface. In this way the appearance of the door 7 is practically equal to that of an ordinary piece of furniture. In FIG. 3 it is shown an arrangement of the capacitive control input system 13 on the second door 7.

The capacitive system 13 can be attached to the back surface 11 of the second door 7 in any desired manner, such as by gluing, by screwing means etc.

As it is well known in the art a capacitive control input system comprises one or more sensors arranged in a matrix that can be placed on the back face of a continuous surface. For activating one of said sensor it is sufficient that a user touches the front face of said surface in a region corresponding to the displacement of the sensor. The touch causes the sensor capacity to change and such change is read by a processor which outputs a signal useful to carry out an operation, as for example, activating a device, turning off a light and so on.

The capacitive control input system 13 used in the present invention is known per se. In FIG. 4 it is shown a possible embodiment of a capacitive system 13 that comprises a board 14 having capacitive sensors 15. Each sensor 15 has a conductive center electrode 16 and a conductive outer electrode 17 which substantially surrounds the center electrode. A channel 18 is located between center electrode 16 and outer electrode 17. The center electrode 16 has dimensions such that the electrode is substantially covered by a user's fingertip when the user touches the surface on which the center electrode 16 is placed. Even if in FIG. 4 the center electrode 16 is square and outer electrode 17 has a square shape which conforms to the shape of the center electrode, it will be understood that various closed, continuous geometric shapes may also be used for the center electrode 16 and for the outer electrode 17 surrounding the former. A sense line 19 is adjacent to outer electrode 17 and carries a detection signal from the sensors 15 to a detection circuitry not shown in FIG. 4.

Capacitive sensors 15 can be arranged in any pattern depending on the particular need and application. Sensors 15 need not to be arranged in rows or columns but may be randomly placed on the board 14 or arranged in a circular or diagonal manner. If desired, more than one capacitive control input system 13 can be attached to the second door 7, for example in its upper corners.

The number of said symbols 10 formed on the outer surface 9 of the second door 7 corresponds to the number of sensors 15 in the capacitive system 13. Furthermore, each symbol 10 is placed in a position facing a sensor 15 such that a user touching a symbol 10 can activate the corresponding sensor 15 for inputting a command to the dishwashing machine. If sensors 15 are placed in particular positions of the second door 7, such as on its upper corners, symbols 10 may not be formed on the outer surface 9 because the user, properly informed, can easily locate the place to be touched for inputting a command to the machine simply referring to the door shape.

The capacitive control input system 13 comprises an electrical connector 20 that can be removably connected to a corresponding socket (not shown in FIG. 4) associated to the first door 2. In this way commands input from the capacitive system 13 are transferred to the dishwashing machine to be operated.

Since the capacitive system 13 must be able to sense the touch of the outer surface 9 by the user, if the second door 7 has a thickness grater than 0.5 [symbol] 1 centimetres, the back surface 11 of the second door 7 facing the first door 2 can be advantageously provided with a blind housing 12 where the input system 13 can be placed, in this way the input system 13 is closer to the front surface 9 of the second door 7 and the touch is sensed. Such an embodiment is illustrated in FIG. 3.

As the present invention may be embodied in several forms without departing from the spirit or essential characteristics thereof, it should also be understood that the above-described embodiment is not limited by any of the details of the foregoing description, but rather should be construed broadly within its spirit and scope as defined in the appended claims, and therefore all changes and modifications that fall within the meets and bounds of the claims, or equivalence of such meets and bounds are therefore intended to be embraced by the appended claims.

1. A built in dishwashing machine comprising a washing chamber, a first door (2) to be opened for accessing the washing chamber and a second door (7) covering the first door (2) characterized in that the second door (7) comprises a capacitive control input system (13) placed between the first door (2) and the second door (7).

2. A built in dishwashing machine according to claim 1 wherein the second door (7) comprises a front surface (9) and a back surface (11) facing the first door and a blind housing (12) provided on the back surface (11) in which the control input system (13) is placed.

3. A built-in dishwashing machine according to claim 1 or 2 wherein the capacitive control input system (13) comprises an electrical connector (20) removably connected to a corresponding socket provided on the first door (2).

4. A built-in dishwashing machine according to claim 1 wherein said capacitive control input system (13) comprises at least one capacitive sensor (15).

5. A built in dishwashing machine according to claim 4 wherein the front surface (9) of said second door (7) is provided with a number of symbols (10) corresponding to the number of the capacitive sensors (15), said symbols (10) being placed in a position facing said capacitive sensors (15).

6. A built in dishwashing machine according to claim 4 wherein said at least one capacitive sensor (15) is placed in a corner of said second door (7).

7. A built-in dishwashing machine according to claim 1 wherein said first door (2) and second door (7) are removably coupled one another such that an opening/closing movement is transferred from the second door (7) to the first door (2).
